(19) United States
(12) Patent Application Publication
(10) Pub. No.: US 2013/0332381 A1
(43) Pub. Date: Dec. 12, 2013

(54) SYSTEM AND METHOD FOR ONLINE HIRING AND VIRTUAL INTERVIEW QUESTIONING

(71) Applicant: Jordan Gilmore Incorporated, Dunmore, PA (US)

(72) Inventors: Brian A. CLARK, Dunmore, PA (US); John W. Guzak, Dunmore, PA (US); Patrick B. Clark, Dunmore, PA (US)

(21) Appl. No.: 13/915,944

(22) Filed: Jun. 12, 2013

Related U.S. Application Data
(60) Provisional application No. 61/658,525, filed on Jun. 12, 2012.

(51) Int. Cl. G06Q 10/10

(52) U.S. Cl. CPC G06Q 10/1053
USPC 705/321

(57) ABSTRACT

A computer-implemented method for virtual interview questioning. The method can include receiving virtual interview elements, receiving additional components for one or more of the virtual interview elements, presenting the virtual interview elements and the additional components to an applicant, receiving responses to the virtual interview elements from the applicant, receiving evaluations of the responses, and calculating a score for the applicant based on the evaluations.

### CROSS-REFERENCE TO RELATED APPLICATIONS

This application claims priority to U.S. Provisional Application 61/658,525, filed Jun. 12, 2012 and entitled SYSTEM, METHOD AND APPARATUS FOR COMPUTER-BASED HIRING AND VIRTUAL INTERVIEW QUESTIONING, the entire contents of which are hereby incorporated by reference.

### BACKGROUND

Traditional paper-based and online recruiting processes typically involve the collection of an applicant's contact information, a resume, and basic qualifying information in the form of questions. The nature of traditional questioning processes may include one or more of yes/no questions, multiple choice questions, and interrogative free-text entry questions. Typically, free-text questions are structured in a fashion whereby a question is presented and the applicant is expected to provide a written free-text response. However, such traditional questions may not provide the applicant with sufficient understanding of the question, or with guidance relative to the nature of the desired response. A solution that facilitates providing the applicant with increased guidance for question responses, as well as facilitates providing a hiring official with improved criteria for response evaluation is therefore desired.

### SUMMARY

According to at least one exemplary embodiment, a computer-implemented method for virtual interview questioning is disclosed. The method can include receiving virtual interview elements, receiving additional components for one or more of the virtual interview elements, presenting the virtual interview elements and the additional components to an applicant, receiving responses to the virtual interview elements from the applicant, receiving evaluations of the responses, and calculating a score for the applicant based on the evaluations.

According to another exemplary embodiment, a system for online hiring and virtual interview questioning is disclosed. The system can include a database storing employer-related data, a database storing applicant-related data, a virtual interview interface, a multimedia cover letter interface, and an interview scheduling interface.

### BRIEF DESCRIPTION OF THE FIGURES

Advantages of embodiments of the present invention will be apparent from the following detailed description of the exemplary embodiments. The following detailed description should be considered in conjunction with the accompanying figures in which:

FIG. 1a is a diagram of an exemplary computer system.

FIG. 1b shows an exemplary system for online hiring and virtual interview questioning.

FIG. 2 shows an exemplary method for online hiring.

FIG. 3 shows an exemplary method for virtual interviewing.

FIG. 4 shows an exemplary interview question interface.

FIG. 5 shows an exemplary multimedia cover letter interface.

FIG. 6 shows an exemplary applicant evaluation interface.

### DETAILED DESCRIPTION

Aspects of the invention are disclosed in the following description and related drawings directed to specific embodiments of the invention. Alternate embodiments may be devised without departing from the spirit or the scope of the invention. Additionally, well-known elements of exemplary embodiments of the invention will not be described in detail or will be omitted so as not to obscure the relevant details of the invention. Further, to facilitate an understanding of the description discussion of several terms used herein follows.

As used herein, the word “exemplary” means “serving as an example, instance or illustration.” The embodiments described herein are not limiting, but rather are exemplary only. It should be understood that the described embodiment are not necessarily to be construed as preferred or advantageous over other embodiments. Moreover, the terms “embodiments of the invention”, “embodiments” or “invention” do not require that all embodiments of the invention include the discussed feature, advantage or mode of operation.

Further, many of the embodiments described herein are described in terms of sequences of actions to be performed by, for example, elements of a computing device. It should be recognized by those skilled in the art that the various sequence of actions described herein can be performed by specific circuits (e.g., application specific integrated circuits (ASICs)) and/or by program instructions executed by at least one processor. Additionally, the sequence of actions described herein can be embodied entirely within any form of computer-readable storage medium such that execution of the sequence of actions enables the processor to perform the functionality described herein. Thus, the various aspects of the present invention may be embodied in a number of different forms, all of which have been contemplated to be within the scope of the claimed subject matter. In addition, for each of the embodiments described herein, the corresponding form of any such embodiments may be described herein as, for example, “a computer configured to” perform the described action.

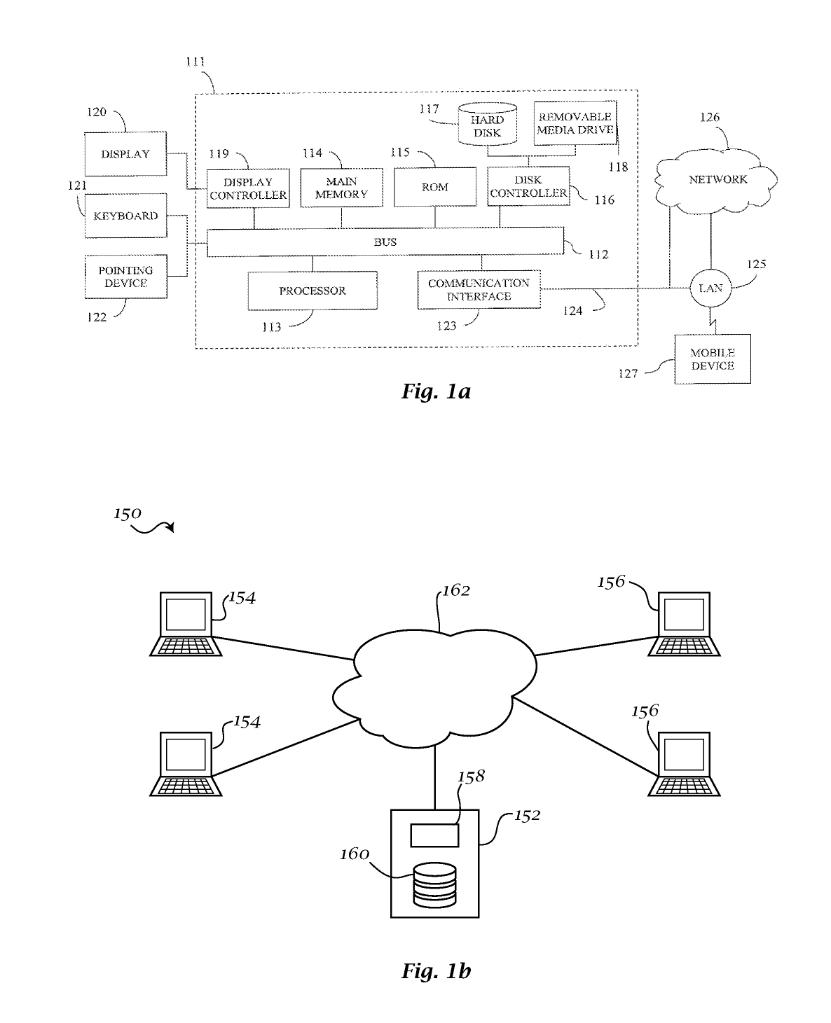

FIG. 1 illustrates a computer system 111 upon which an embodiment of the present invention may be implemented. The computer system 111 includes a bus 112 or other communication mechanism for communicating information, and a processor 113 coupled with the bus 112 for processing the information. The computer system 111 also includes a main memory 114, such as a random access memory (RAM) or other dynamic storage device (e.g., dynamic RAM (DRAM), static RAM (SRAM), and synchronous DRAM (SDRAM)), coupled to the bus 112 for storing information and instructions to be executed by processor 113. In addition, the main memory 114 may be used for storing temporary variables or other intermediate information during the execution of instructions by the processor 113. The computer system 111 further includes a read only memory (ROM) 115 or other static storage device (e.g., programmable ROM (PROM), erasable PROM (EPROM), and electrically erasable PROM (EEPROM)) coupled to the bus 112 for storing static information and instructions for the processor 113.

The computer system 111 also includes a disk controller 116 coupled to the bus 112 to control one or more storage devices for storing information and instructions, such as a magnetic hard disk 117, and a removable media drive 118 (e.g., floppy disk drive, read-only compact disc drive, read/write compact disc drive, compact disc jukebox, tape drive, and removable magneto-optical drive). The storage devices may be added to the computer system 111 using an appropriate device interface (e.g., small computer system interface (SCSI), integrated device electronics (IDE), enhanced-IDE (E-IDE), direct memory access (DMA), or ultra-DMA).

Further, exemplary embodiments include or incorporate at least one database which may store software, descriptive data, system data, digital images and any other data item required by the other components necessary to effectuate any embodiment of the present system known to one having ordinary skill in the art. The database may be provided, for example, as a database management system (DBMS), a relational database management system (e.g., DB2, ACCESS, etc.), an object-oriented database management system (ODBMS), a file system or another conventional database package as a few non-limiting examples. The database can be accessed via a Structure Query Language (SQL) or other tools known to one having skill in the art.

Still referring to FIG. 1, the computer system 111 may also include special purpose logic devices (e.g., application specific integrated circuits (ASICs)) or configurable logic devices (e.g., simple programmable logic devices (SPLDs), complex programmable logic devices (CPLDs), and field programmable gate arrays (FPGAs)).

The computer system 111 may also include a display controller 119 coupled to the bus 112 to control a display 120, such as a cathode ray tube (CRT), liquid crystal display (LCD) or any other type of display, for displaying information to a computer client. The computer system includes input devices, such as a keyboard 121 and a pointing device 122, for interacting with a computer client and providing information to the processor 113. Additionally, a touch screen could be employed in conjunction with display 120. The pointing device 122, for example, may be a mouse, a trackball, or a pointing stick for communicating direction information and command selections to the processor 113 and for controlling cursor movement on the display 120. In addition, a printer may provide printed listings of data stored and/or generated by the computer system 111.

The computer system 111 performs a portion or all of the processing steps of the invention in response to the processor 113 executing one or more sequences of one or more instructions contained in a memory, such as the main memory 114. Such instructions may be read into the main memory 114 from another computer readable medium, such as a hard disk 117 or a removable media drive 118. One or more processors in a multi-processing arrangement may also be employed to execute the sequences of instructions contained in main memory 114. In alternative embodiments, hard-wired circuitry may be used in place of or in combination with software instructions. Thus, embodiments are not limited to any specific combination of hardware circuitry and software.

As stated above, the computer system 111 includes at least one computer readable medium or memory for holding instructions programmed according to the teachings of the invention and for containing data structures, tables, records, or other data described herein. Examples of computer readable media are compact discs, hard disks, floppy disks, tape, magneto-optical disks, PROMs (EPROM, EEPROM, flash EPROM), DRAM, SRAM, SDRAM, or any other magnetic medium, compact discs (e.g., CD-ROM), or any other optical medium, punch cards, paper tape, or other physical medium with patterns of holes, a carrier wave (described below), or any other medium from which a computer can read.

Stored on any one or on a combination of computer readable media, the present invention includes software for controlling the computer system 111, for driving a device or devices for implementing the invention, and for enabling the computer system 111 to interact with a human client. Such software may include, but is not limited to, device drivers, operating systems, development tools, and applications software. Such computer readable media further includes the computer program product of the present invention for performing all or a portion (if processing is distributed) of the processing performed in implementing the invention.

The computer code devices of the present invention may be any interpretable or executable code mechanism, including but not limited to scripts, interpretable programs, dynamic link libraries (DLLs), Java classes, and complete executable programs. Moreover, parts of the processing of the present invention may be distributed for better performance, reliability, and/or cost.

The term “computer readable medium” as used herein refers to any medium that participates in providing instructions to the processor 113 for execution. A computer readable medium may take many forms, including but not limited to, non-volatile media, volatile media, and transmission media. Non-volatile media includes, for example, optical, magnetic disks, and magneto-optical disks, such as the hard disk 117 or the removable media drive 118. Volatile media includes dynamic memory, such as the main memory 114. Transmission media includes coaxial cables, copper wire and fiber optics, including the wires that make up the bus 112. Transmission media also may also take the form of acoustic or light waves, such as those generated during radio wave and infrared data communications.

Various forms of computer readable media may be involved in carrying out one or more sequences of one or more instructions to processor 113 for execution. For example, the instructions may initially be carried on a magnetic disk of a remote computer. The remote computer can load the instructions for implementing all or a portion of the present invention remotely into a dynamic memory and send the instructions over a telephone line using a modem. A modem local to the computer system 111 may receive the data on the telephone line and use an infrared transmitter to convert the data to an infrared signal. An infrared detector coupled to the bus 112 can receive the data carried in the infrared signal and place the data on the bus 112. The bus 112 carries the data to the main memory 114, from which the processor 113 retrieves and executes the instructions. The instructions received by the main memory 114 may optionally be stored on storage device 117 or 118 either before or after execution by processor 113.

The computer system 111 also includes a communication interface 123 coupled to the bus 112. The communication interface 123 provides a two-way data communication coupling to a network link 124 that is connected to, for example, a local area network (LAN) 125, or to another communications network 126 such as the Internet. For example, the communication interface 123 may be a network interface card to attach to any packet switched LAN. As another example, the communication interface 123 may be a wireless link. In any such implementation, the communication interface 123 sends and receives electrical, electromagnetic or optical signals that carry digital data streams representing various types of information.

The network link 124 typically provides data communication through one or more networks to other data devices. For example, the network link 124 may provide a connection to another computer or remotely located presentation device through a local network 125 (e.g., an 802.11-compliant wireless network) or through equipment operated by a service provider, which provides communication services through a communications network 126. In preferred embodiments, the local network 124 and the communications network 126 preferably use electrical, electromagnetic, or optical signals that carry digital data streams. The signals through the various networks and the signals on the network link 124 and through the communication interface 123, which carry the digital data to and from the computer system 111, are exemplary forms of carrier waves transporting the information. The computer system 111 can transmit and receive data, including program code, through the network(s) 125 and 126, the network link 124 and the communication interface 123. Moreover, the network link 124 may provide a connection through a LAN 125 to a mobile device 127 such as a personal digital assistant (PDA) laptop computer, or cellular telephone. The LAN communications network 125 and the communications network 126 both use electrical, electromagnetic or optical signals that carry digital data streams. The signals through the various networks and the signals on the network link 124 and through the communication interface 123, which carry the digital data to and from the system 111, are exemplary forms of carrier waves transporting the information. The processor system 111 can transmit notifications and receive data, including program code, through the network(s), the network link 124 and the communication interface 123.

Other aspects of the invention may include data transmission and Internet-related activities. See Preston Gralla, How the Internet Works, Ziff-Davis Press (1996), which is hereby incorporated by reference into this patent application. Still other aspects of the invention may utilize wireless data transmission, such as those described in U.S. Pat. Nos. 6,456,645, 5,818,328 and/or 6,208,445, all of which are hereby incorporated by reference into this patent application.

FIG. 1b shows an exemplary embodiment of a system for online hiring and virtual interview questioning 150. System 150 can include a server 152. Server 152 may be in communication with a plurality of applicant computing devices 154 as well as a plurality of employer computing devices 156. Server 152 can include a non-transitory computer-readable medium for storing software 158 adapted to perform the methods described herein, as well as one or more databases 160 for storing a variety of data, for example employer related data and applicant-related data. The server 152 and computing devices 154, 156 may be communicatively coupled via a communications network 162 such as the Internet. Computing devices 154, 156 may be any known computing device, including personal computers and mobile communication devices.

Server 152 may function in a manner so as to provide and store any of a variety of data. For example, when accessed via network 162, server 152 may provide website content and website access. In such an example, user at a computer device 154 or 156 may be able to navigate to a website housed on server 152. The user may then be able to view data or gain access to an area of the website that is customized for that user, for example pages providing user-desired content and user-provided information.

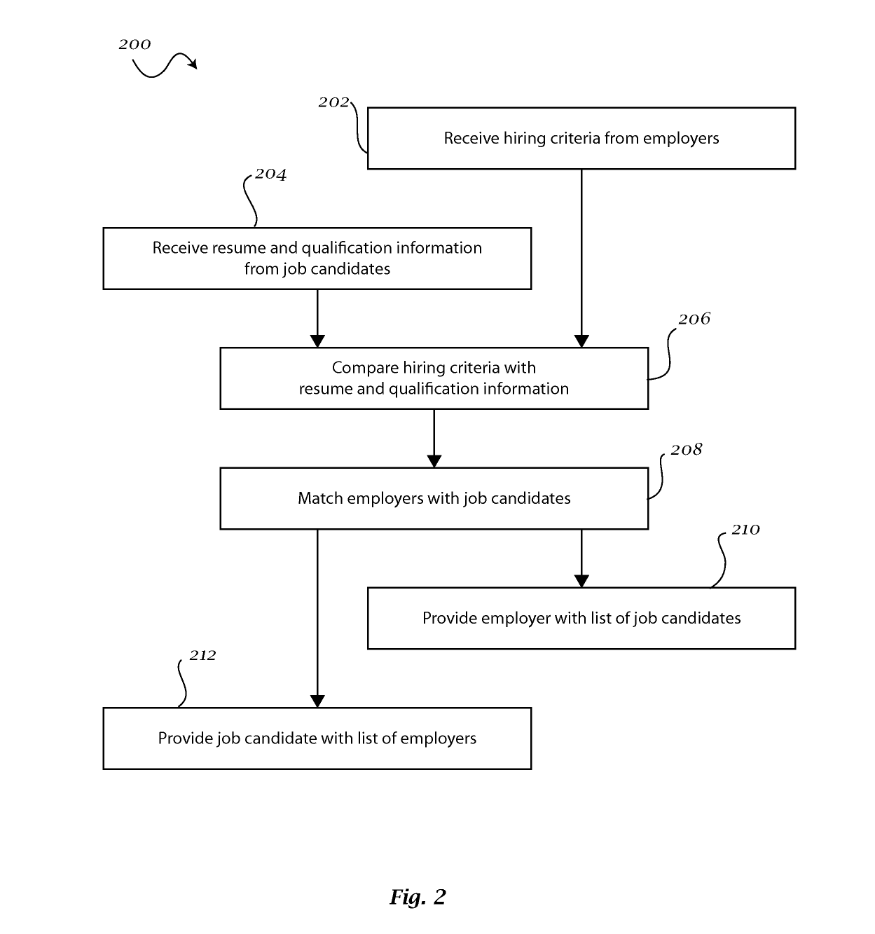

Turning to FIG. 2, an exemplary embodiment of a method for online hiring 200 may be disclosed. At step 202, a system for online hiring may receive employee criteria from employers. At step 204, the system can also receive resume and qualification information from job candidates. At step 206, the system can compare the employee criteria input by the employers and the resume and qualification information input by the job candidates. The comparison may be performed by comparing employee responses to an employer's hiring questions with the employer's desired responses to the questions. At step 208, the system may match candidates with employers based on the comparison performed in step 206. At step 210, the system can provide an employer with a list of suitable job candidates based on the matching performed in step 208. Similarly, at step 212, the system can provide a job candidate with a list of employer matches based on the matching performed in step 208. The candidate and employer can then commence the interview process, which can include a virtual interview questioning process, substantially as described below.

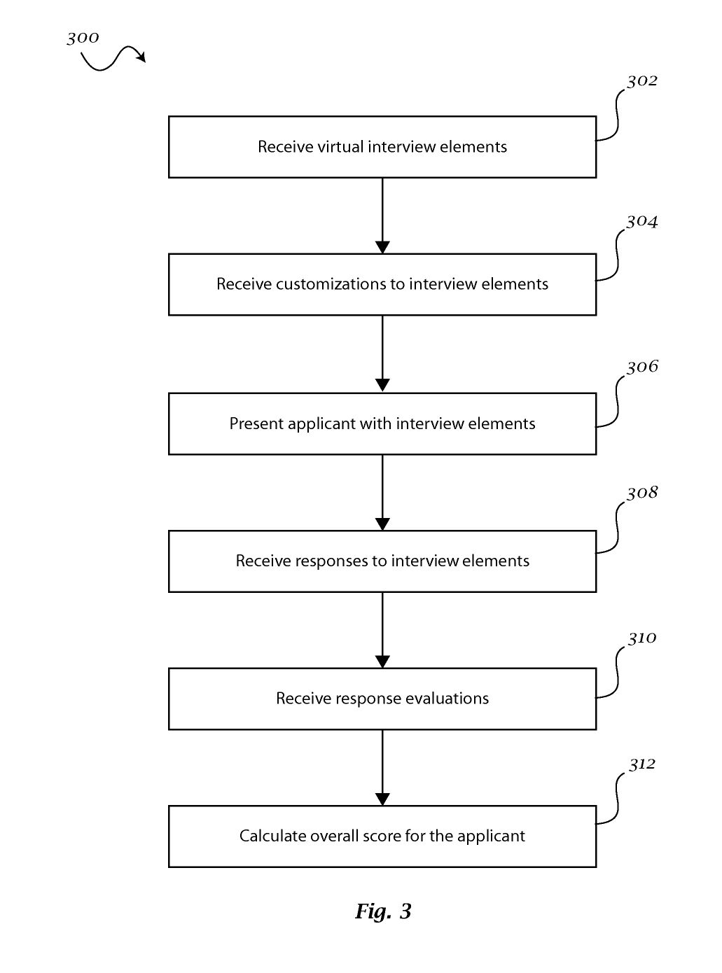

FIG. 3 shows an exemplary method for virtual interviewing. At step 302, a plurality of virtual interview elements for an employment position may be received by the system for online hiring. The virtual interview elements may be selected by an employer, for example, via one or more interfaces of the system. The virtual interview elements can be categories of information about an applicant that an employer desires to receive. The interview elements can include question sets, such as soft skill question sets, hard skill question sets, and interview question sets, and so forth. The interview elements can further include application portions, such as cover letters, which such as written, video, or audio cover letters, resumes, reference lists, and so forth. The interview elements can further include the history and records of the applicant, such as education history, career history, residence history, driving records, criminal records, background check information, government agency disclosures, and so forth. The interview elements can further include tests, such as skills tests, assessment tests, personality tests, aptitude tests, and so forth. An employer can select any desired number of interview elements to include in a virtual interview. This can allow the employer to configure a virtual interview so as to focus on the particular interview elements and applicant characteristics that are relevant, significant, or otherwise pertinent to the employer and the particular employment position.

At step 304, additional components of the virtual interview elements may be received. For example, question sets, such as interview question sets, may be customized by the employer by providing additional components for each question in the interview question set. Such components can include, for example, question text content, background content, and response tip content.

The question background content can include background information relating to the question itself, such as context for the question, advance information about the question, elaboration on the nature of the question, and so forth. This can provide the applicant with information about the interview question, so as to set expectations for the interview question. Furthermore, the background content can benefit the applicant by providing the applicant with greater insight into the nature of the question. The background content can also benefit the employer by increasing the likelihood of the applicant providing a response to the question that is in concert with the context of the question, as well as allowing the employer to determine that the applicant ignored the background or context that was provided in background field if the applicant provided an out-of-context response.

The question text content can include the actual interrogative interview question that is to be answered by the applicant.

The response tip content can include information providing guidance as to how the applicant should answer the interview question. For example, the response tip content can describe which information the employer is seeking in response to the question, the amount of information that would constitute a complete answer to the question, the desired focus of the answer to the question, and so forth. The response tip content can encourage the applicant to draft an answer to the interview question such that the answer has all information desired by the employer. This can benefit the employer by increasing the likelihood of the applicant providing a response that includes all desired information relative to the question. Similarly, if the applicant provided a response not having the information indicated in the response tip, the employer can easily ascertain that the applicant ignored the response tip content.

At step 306, the virtual interview elements may be presented to the applicant. The virtual interview elements may be presented to the applicant, for example, via one or more interfaces of the system. The applicant can then provide desired content in response to the interview elements, such as answers to interview questions, application portions, history and records, test responses or scores, and so forth. At step 308, the responses of the applicant may be received.

At step 310, evaluations of the applicant's responses may be received by the system. The evaluation may be performed, for example, by the employer. The responses may be evaluated based on a plurality of criteria. For example, for answers to interview questions, the criteria can include, but are not limited to, the content of the answer to the question, as well as the relevance and completeness of the applicant's response in light of the background information and the response tip provided for each question. The evaluation may be performed, for example, by assigning a rating to each answer based on the above-described criteria, as well as any other criteria desired by the employer. Other portions of the applicant's responses may also be evaluated based on any criteria desired by the employer.

At step 312, an overall score for the particular applicant may be calculated. The overall applicant score may be calculated, for example, by the system, by determining the average of the rating evaluations for the answers to interview questions. Any additional desired factors for calculating the overall score may also be considered and factored into the final value. Additionally, any other portion of the applicant's responses may also be considered and factored into the final value.

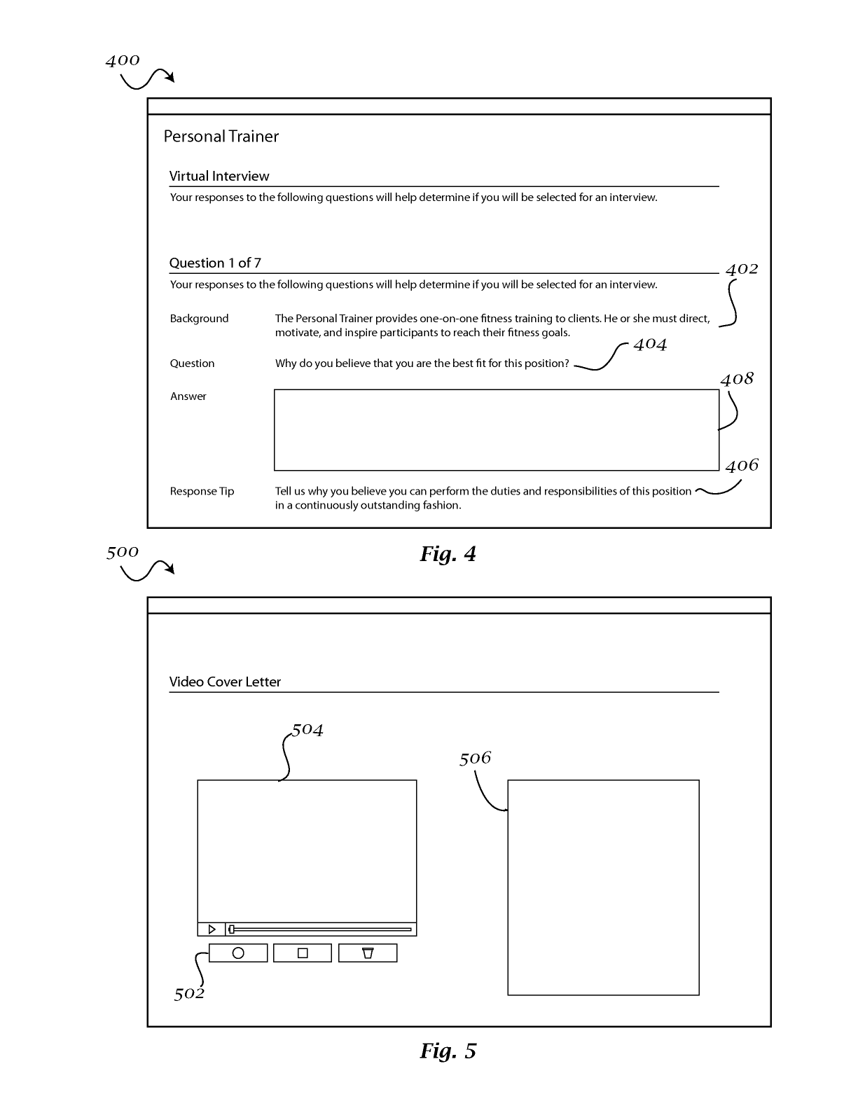

FIG. 4 shows an exemplary embodiment of an interview question interface 400 of the system for online hiring. The interview interface 400 may be presented to a user, for example an applicant for an employment position, or to an employer. When presented to the applicant, interview interface 400 can allow the applicant to answer the interview question being presented. When presented to the employer, the interview interface 400 can allow the employer to author the interview question, background content, and response tip content.

Interview interface 400 can include a background field 402, a question field 404, a response tip field 406. When presented to an applicant, the interview can further include an answer field 408, with fields 402, 404, 406 being non-editable and field 408 being editable. When presented to an employer, fields 402, 404, 406 may be editable. Furthermore, an employer can enter content into some or all of fields 402, 404, 406. Only the fields having content entered therein may be visible when presented to the applicant.

FIG. 5 shows an exemplary embodiment of a multimedia cover letter interface 500 of the system for online hiring. The multimedia cover letter interface may be presented to an applicant and can allow the applicant to record a video or audio recording and to upload the recorded content to the system. The multimedia cover letter interface 500 can include buttons 502 for recording audio or video content, discarding the audio or video content, or re-recording the audio or video content. A limit for the length of the recorded content may be set by the employer. The multimedia cover letter interface 500 can further include a playback widget 504, which can allow the user to view the recorded video content or listen to the recorded audio content. Interface 500 can further include a notes field 506, which may be editable by the applicant and may be used by the applicant, for example as speaking notes, while recording the multimedia content. Multimedia cover letters can be beneficial in the case of applicants for customer service positions, sales positions, and other positions involving interaction with customers, and can help the employer evaluate the applicant's presence and speaking skills.

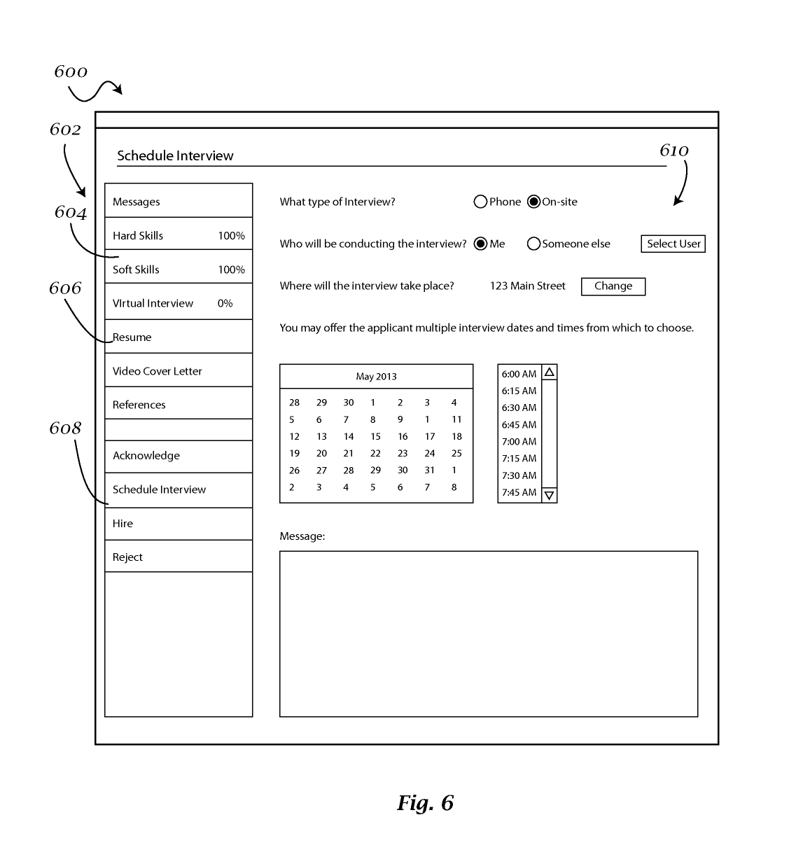

FIG. 6 shows an exemplary applicant evaluation interface 600 that may be presented to an employer. Applicant evaluation interface 600 can include a navigation and information bar 602 that can allow the employer to view the applicant's evaluation scores 604, as well as to view various portions of the applicant's application 606, including cover letters and the responses to the employer's desired virtual interview elements. The applicant evaluation interface can further allow to execute various actions 608, such as acknowledge receipt of the application, set up an interview with the applicant, reject the applicant, or hire the applicant.

The content portion 610 of interface 600 can display content related to the score, portion of the application, or action that is selected by the employer. For example, content portion 610 may display an interview scheduling interface, as shown in FIG. 6. The interview scheduling interface can allow the employer to set aspects of the interview, for example a phone or on-site interview, the person who will be conducting the interview, the location of the interview, one or more interview dates and times to present to the applicant, and a pre-written message to send to the applicant. The pre-written message may be editable or non-editable depending on the permissions of the particular individual sending the message. Once the applicant accepts the interview, the system can communicate with the employer's desired computer-based calendar systems so as to create an event for the interview.

The system for online hiring may communicate with an applicant in response to an action by the applicant, or in the event that an action by an applicant is required. For example, the system for online hiring may contact an applicant to acknowledge application submission, to inform the applicant of an interview request, to inform the applicant of a background check request, to notify the applicant that they have been hired or rejected, and so forth. Communications between the system for online hiring and an applicant may be performed in a variety of manners, for example email, text messaging, or voice calls. So as to reduce the likelihood of an applicant missing an email notification from the system, for example due to a spam filter or to oversight, the communications from the system to the applicant may be delivered via several diverse manners. For example, whenever an email communication is sent from the system to an applicant, a text message may also be sent to the applicant's mobile device informing the applicant of the email communication.

Thus, the systems and methods disclosed herein can provide a hiring and questioning methodology which can provide the hiring official increased insight with regard to an applicant's potential. The introduction of background or context to a given question can introduce a valuable dimension in terms of question comprehension, and the response tip can enable the hiring official to glean as much relevant information from the job applicant while providing the applicant additional instructions relative to the response content. Through the use of this questioning methodology, the hiring official can obtain more precise answers to the interrogative questions presented to the applicant.

The foregoing description and accompanying figures illustrate the principles, preferred embodiments and modes of operation of the invention. However, the invention should not be construed as being limited to the particular embodiments discussed above. Additional variations of the embodiments discussed above will be appreciated by those skilled in the art.

Therefore, the above-described embodiments should be regarded as illustrative rather than restrictive. Accordingly, it should be appreciated that variations to those embodiments can be made by those skilled in the art without departing from the scope of the invention as defined by the following claims.

What is claimed is:

1. A computer-implemented method for virtual interview questioning, comprising:
receiving virtual interview elements;
receiving additional components for one or more of the virtual interview elements;
presenting the virtual interview elements and the additional components to an applicant;
receiving responses to the virtual interview elements from the applicant;
receiving evaluations of the responses; and
calculating a score for the applicant based on the evaluations.

2. The method of claim 1, wherein the virtual interview elements include one or more of a question set, an application portion, applicant history, applicant records, or a test.

3. The method of claim 2, wherein the question set includes one or more of a soft skills question set, a hard skills question set, and a virtual interview question set.

4. The method of claim 2, wherein the application portion includes one or more of a cover letter, a resume and a reference list.

5. The method of claim 2, wherein the applicant history includes one or more of a education history, career history, and residence history.

6. The method of claim 2, wherein the applicant records include one or more of a driving records, criminal records, background check information, and government agency disclosures.

7. The method of claim 2, wherein the tests include one or more of skills tests, assessment tests, personality tests, and aptitude tests.

8. The method of claim 1, wherein the additional components include one or more of a background for a virtual interview element and a response tip for a virtual interview element.

9. The method of claim 1, further comprising evaluating the responses based on the virtual interview element and the additional components.

10. A non-transitory computer readable medium storing a set of computer readable instructions that, when executed by one or more processors, causes a device to perform a process comprising:
receiving virtual interview elements;
receiving additional components for one or more of the virtual interview elements;
presenting the virtual interview elements and the additional components to an applicant;
receiving responses to the virtual interview elements from the applicant;
receiving evaluations of the responses; and
calculating a score for the applicant based on the evaluations.

11. The non-transitory computer readable medium of claim 1, wherein the virtual interview elements include one or more of a question set, an application portion, applicant history, applicant records, or a test.

12. The non-transitory computer readable medium of claim 1, wherein the additional components include one or more of a background for a virtual interview element and a response tip for a virtual interview element.

13. A system for online hiring and virtual interview questioning, comprising:
a server;
an employer database stored on the server for storing employer-related data;
an applicant database stored on the server for storing applicant-related data;
at least one client computer in communication with the server, each client computer adapted to display at least a virtual interview interface, a multimedia cover letter interface, and an interview scheduling interface.

14. The system of claim 13, wherein the virtual interview interface includes a question field, a background field and a response tip field.

15. The system of claim 13, wherein the multimedia cover letter interface is adapted to allow an applicant to record multimedia content and transmit the recorded content to an employer.

16. The system of claim 15, wherein the multimedia content is audio content.

17. The system of claim 15, wherein the multimedia content is video content.

18. The system of claim 13, wherein the interview scheduling interface is adapted to allow an employer to select an interview type, select the individual conducting the interview, and select the location and time of the interview.
